(19) United States
(12) Patent Application Publication
(10) Pub. No.: US 2024/0059815 A1
(43) Pub. Date: Feb. 22, 2024

(54) OLEFIN-BASED POLYMER, AND METHOD FOR PREPARING THE SAME

(71) Applicant: HANWHA SOLUTIONS CORPORATION, Seoul (KR)

(72) Inventors: Sung Dong KIM, Daejeon (KR); Munhee LEE, Daejeon (KR); Ui Cap JOUNG, Daejeon (KR); Jeong Hyun PARK, dAEJEON (KR); Junho SEO, Daejeon (KR); Seongjae LIM, Daejeon (KR); Jisong JO, Daejeon (KR); Hye Ran PARK, Daejeon (KR)

(73) Assignee: HANWHA SOLUTIONS CORPORATION, Seoul (KR)

(21) Appl. No.: 18/267,678

(22) PCT Filed: Dec. 10, 2021
(86) PCT No.: PCT/KR2021/018720

§ 371 Date: Jun. 15, 2023

(30) Foreign Application Priority Data
Dec. 17, 2020 (KR) 10-2020-0177009

(51) Int. Cl. C08F 210/16

(52) U.S. Cl. CPC C08F 210/16

(57) ABSTRACT

The present invention relates to an olefin-based polymer, and a method for preparing the same. The olefin-based polymer according to an embodiment of the present invention has a wide molecular weight distribution and thus has excellent processability. Moreover, a relatively large number of short-chain branches are present in high molecular weight components of the olefin-based polymer, and thus the olefin-based polymer has excellent mechanical strength and heat-sealing properties.

### TECHNICAL FIELD

The present invention relates to an olefin-based polymer and a method for preparing the same. Specifically, the present invention relates to an olefin-based polymer having excellent mechanical strength and a method for preparing the same.

### BACKGROUND ART

A metallocene catalyst which is one of the catalysts used in olefin polymerization, which is a compound in which a ligand such as cyclopentadienyl, indenyl, or cycloheptadienyl is coordinated to a transition metal compound or a transition metal halogen compound, has a sandwich structure as a basic form.

A Ziegler-Natta catalyst which is another catalyst used for polymerizing olefins has heterogeneous properties of an active site, since a metal component as an active site is dispersed on an inert solid surface; however, the metallocene catalyst is known as a single-site catalyst having identical polymerization properties in all active sites, since it is one compound having a certain structure. A polymer polymerized with the metallocene catalyst as such has a narrow molecular weight distribution, a uniform comonomer distribution, and copolymerization activity higher than the Ziegler Natta catalyst.

Meanwhile, a linear low-density polyethylene (LLDPE) is prepared by copolymerizing ethylene and α-olefin at a low pressure using a polymerization catalyst, has a narrow molecular weight distribution and a short chain branch (SCB) having a certain length, and does not have a long chain branch (LCB) in general. A film prepared with a linear low-density polyethylene has high breaking strength and elongation, and excellent tear strength, impact strength, and the like, together with general properties of polyethylene, and thus, is widely used in a stretch film, an overlap film, and the like to which it is conventionally difficult to apply low-density polyethylene or high-density polyethylene.

However, the linear low-density polyethylene prepared by a metallocene catalyst has poor processability due to a narrow molecular weight distribution, and a film prepared therefrom tends to have reduced heat seal properties.

Therefore, an olefin-based polymer which allows preparation of a film which has excellent mechanical strength and heat seal properties while having excellent processability, is being demanded.

### DISCLOSURE

### Technical Problem

An object of the present invention is to provide an olefin-based polymer which allows preparation of an olefin-based polymer film which has excellent mechanical strength and heat seal properties while having excellent processability.

Another object of the present invention is to provide a method for preparing the olefin-based polymer.

### Technical Solution

In one general aspect, an olefin-based polymer which has (1) a density of 0.915 to 0.935 g/cm³, preferably 0.918 to 0.932 g/cm³; (2) a ratio between a melt index (I_{21.6}) measured with a load of 21.6 kg and a melt index (I_{2.16}) measured with a load of 2.16 kg at 190° C. (melt flow ratio; MFR) of 15 or more, preferably 15 to 40; and (3) a comonomer distribution slope (CDS) defined by the following Equation 1 of 1.0 or more, preferably 1.0 to 3.0:

$$CDS = \frac{log {C}_{80} - log {C}_{20}}{log {M}_{80} - log {M}_{20}} \qquad [ Equation 1 ]$$

wherein C₂₀ and C₈₀ are comonomer contents at points where cumulative weight fractions are 20% and 80%, respectively, in a comonomer distribution, and M₂₀ and M₈₀ are molecular weights at points where cumulative weight fractions are 20% and 80%, respectively, in a comonomer distribution.

In a specific example of the present invention, the olefin-based polymer may be prepared by polymerizing an olefin-based monomer in the presence of a hybrid catalyst including at least one first transition metal compound represented by the following Chemical Formula 1; and at least one second transition metal compound represented by the following Chemical Formula 2:

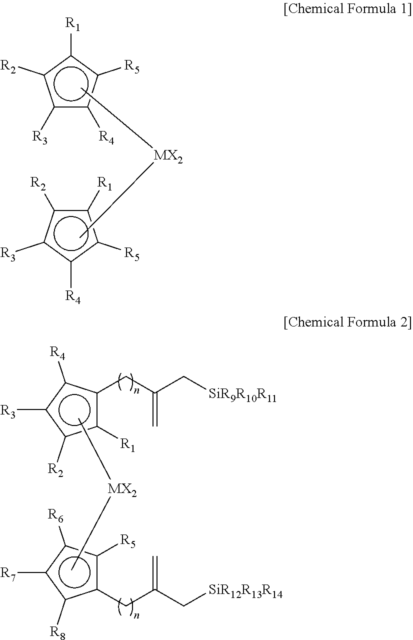

wherein n is independently of each other an integer of 1 to 20,
M is independently of each other titanium (Ti), zirconium (Zr), or hafnium (Hf),
X is independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido,
R₁ to R₈ are independently of one another hydrogen, substituted or unsubstituted C₁₋₂₀ alkyl, substituted or unsubstituted C₂₋₂₀ alkenyl, substituted or unsubstituted C₈₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, and
R₉ to R₁₁ and R₁₂ to R₁₄ are independently of one another substituted or unsubstituted C₁₋₂₀ alkyl, substituted or unsubstituted C₂₋₂₀ alkenyl, substituted or unsubstituted C₈₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, but
R₁ to R₈ may be independently of one another connected to an adjacent group to form a substituted or unsubstituted and saturated or unsaturated C₄₋₂₀ ring.

In a specific example of the present invention, M may be zirconium or hafnium, respectively, X may be halogen or C₁₋₂₀ alkyl, respectively, R₁ to R₈ may be hydrogen, substituted or unsubstituted C₁₋₂₀ alkyl, substituted or unsubstituted C₁₋₂₀ alkenyl, or substituted or unsubstituted C₆₋₂₀ aryl, respectively, and R₉ to R₁₁ and R₁₂ to R₁₄ may be substituted or unsubstituted C₁₋₂₀ alkyl, respectively.

In a preferred specific example of the present invention, the first transition metal compound may be at least one of transition metal compounds represented by the following Chemical Formulae 1-1 to 1-3, and the second transition metal compound may be a transition metal compound represented by the following Chemical Formula 2-1:

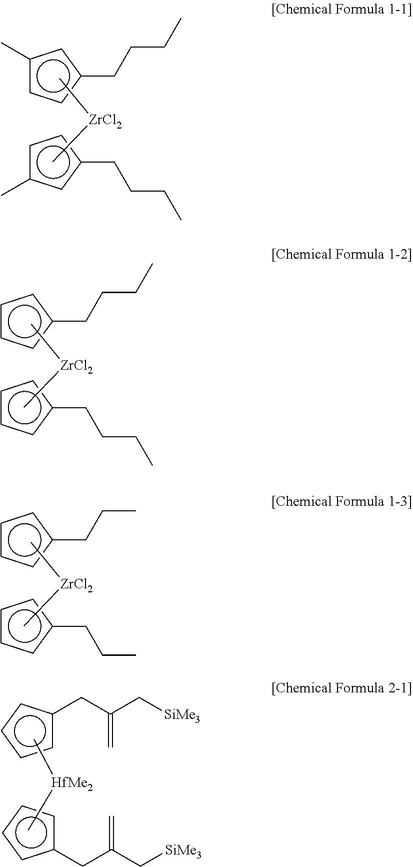

wherein Me is a methyl group.

In a specific example of the present invention, a mole ratio of the first transition metal compound to the second transition metal compound is in a range of 100:1 to 1:100.

In a specific example of the present invention, the catalyst may include at least one cocatalyst selected from the group consisting of a compound represented by the following Chemical Formula 3, a compound represented by the following Chemical Formula 4, and a compound represented by the following Chemical Formula 5:

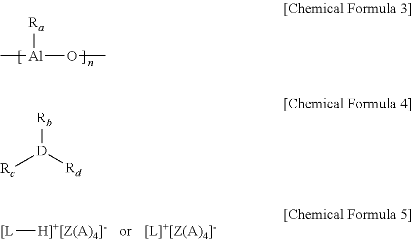

wherein n is an integer of 2 or more, Rₐ is a halogen atom, a C₁₋₂₀ hydrocarbon group, or a C₁₋₂₀ hydrocarbon group substituted with halogen,
D is aluminum (Al) or boron (B), R_{b}, R_{C}, and R_{d} are independently of one another a halogen atom, a C₁₋₂₀ hydrocarbon group, a C₁₋₂₀ hydrocarbon group substituted with halogen, or a C₁₋₂₀ alkoxy group,
L is a neutral or cationic Lewis base, [L-H]⁺ and [L]⁺ are a Bronsted acid, Z is a group 13 element, and A is independently of each other a substituted or unsubstituted C₆₋₂₀ aryl group or a substituted or unsubstituted C₁₋₂₀ alkyl group.

In a specific example of the present invention, the catalyst may further include a carrier which supports a transition metal compound, a cocatalyst compound, or both of them.

In a preferred specific example of the present invention, the carrier may include at least one selected from the group consisting of silica, alumina, and magnesia.

Herein, a total amount of the hybrid transition metal compound supported on the carrier may be 0.001 to 1 mmol based on 1 g of the carrier, and a total amount of the cocatalyst compound supported on the carrier may be 2 to 15 mmol based on 1 g of the carrier.

In a specific example of the present invention, the olefin-based polymer may be a copolymer of an olefin-based monomer and an olefin-based comonomer. Specifically, the olefin-based monomer may be ethylene, and the olefin-based comonomer may be at least one selected from the group consisting of propylene, 1-butene, 1-pentene, 4-methyl-1-pentene, 1-hexene, 1-heptene, 1-octene, 1-decene, 1-undecene, 1-dodecene, 1-tetradecene, and 1-hexadecene. Preferably, the olefin-based polymer may be a linear low-density polyethylene in which the olefin-based polymer is ethylene and the olefin-based monomer is 1-hexene.

In another general aspect, a method for preparing an olefin-based polymer includes: polymerizing an olefin-based monomer in the presence of a hybrid catalyst including: at least one first transition metal compound represented by Chemical Formula 1; and at least one second transition metal compound represented by Chemical Formula 2, thereby obtaining an olefin-based polymer, wherein the olefin-based polymer has (1) a density of 0.915 to 0.935 g/cm³, preferably 0.918 to 0.932 g/cm³; (2) a ratio between a melt index (I_{21.6}) measured with a load of 21.6 kg and a melt index (I_{2.16}) measured with a load of 2.16 kg at 190° C. (melt flow ratio; MFR) of 15 or more, preferably 15 to 40; and (3) a comonomer distribution slope (CDS) defined by the Equation 1 of 1.0 or more, preferably 1.0 to 3.0.

In a specific example of the present invention, polymerization of the olefin-based monomer may be performed by slurry polymerization, and specifically, the polymerization of the olefin-based monomer may be performed in a slurry batch reactor.

### Advantageous Effects

The olefin-based polymer according to an exemplary embodiment of the present invention has a wide molecular weight distribution and thus has excellent processability. Moreover, a relatively large number of short-chain branches are present in high molecular weight components of the olefin-based polymer, and thus the olefin-based polymer has excellent mechanical strength and heat-sealing properties.

### DESCRIPTION OF DRAWINGS

FIG. 1 is a GPC-FTIR graph for describing a method for measuring CDS defined by Equation 1.

FIGS. 2 to 9 are GPC-FTIR graphs for measuring CDS of olefin-based polymers of Examples 1 to 8, respectively.

FIGS. 10 and 11 are GPC-FTIR graphs for measuring CDS of olefin-based polymers of Comparative Examples 1 and 2, respectively.

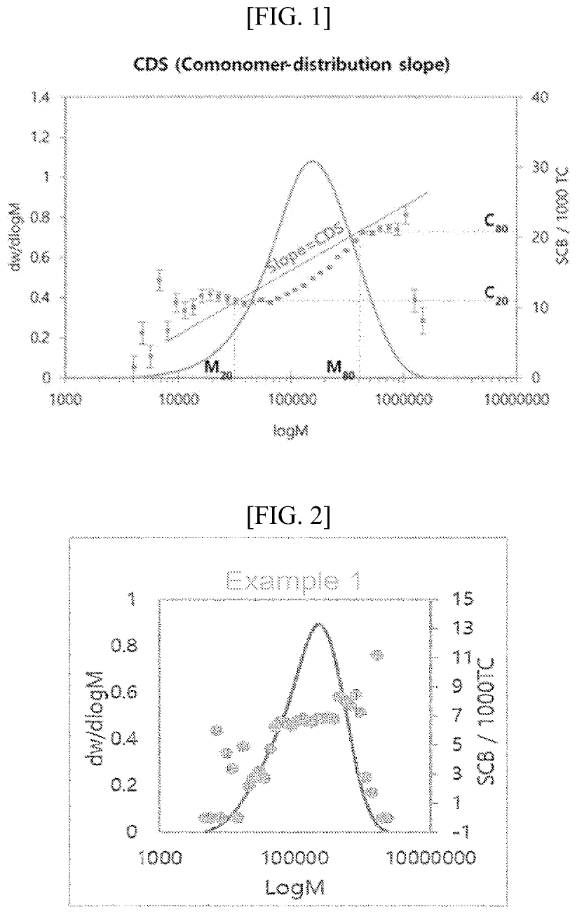

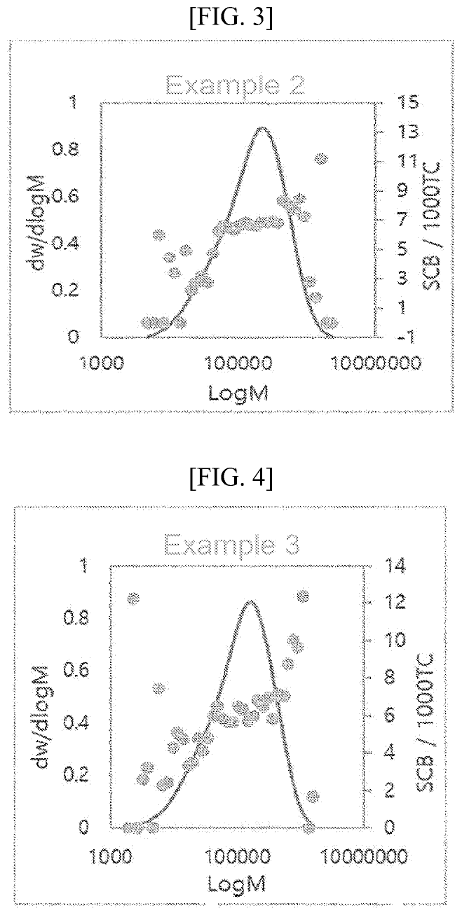

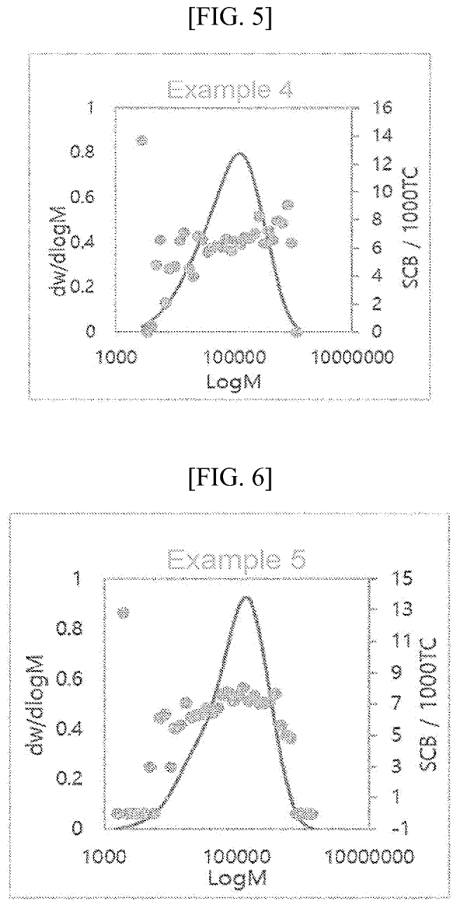

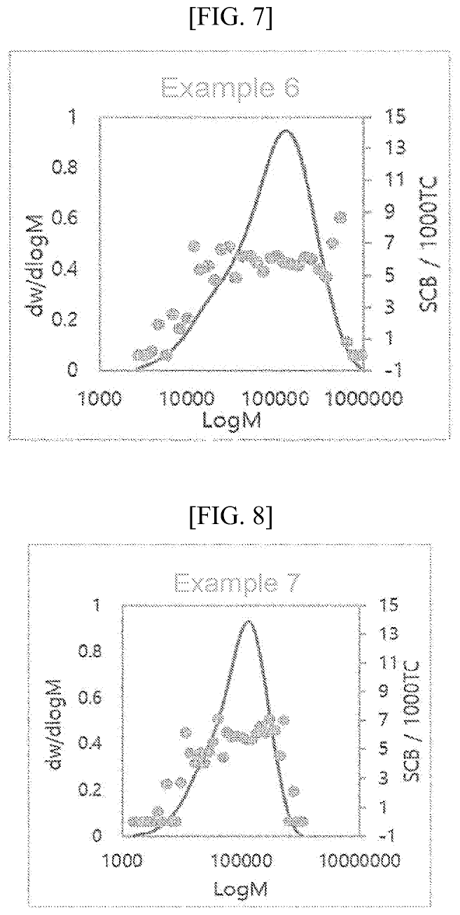

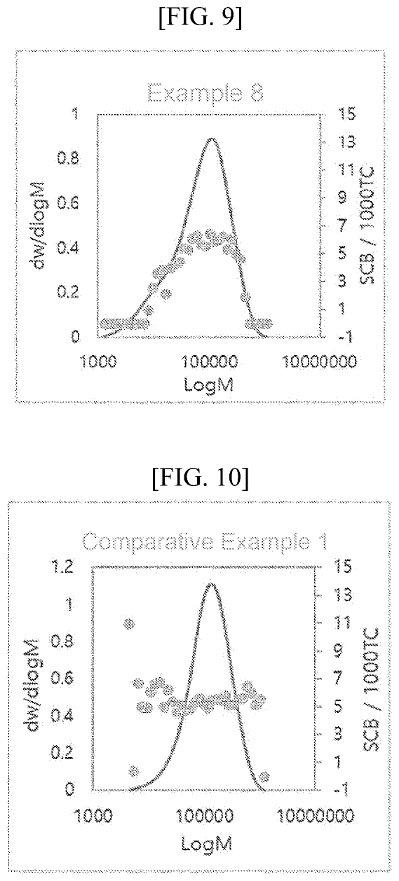

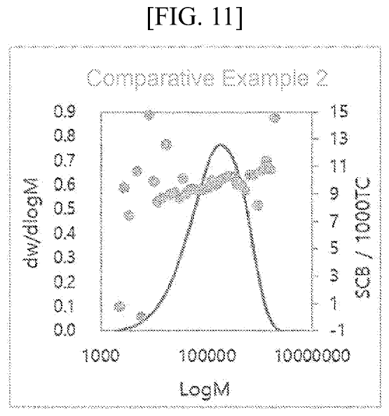

### BEST MODE

Hereinafter, the present invention will be described in more detail.

### Olefin-Based Polymer

According to an exemplary embodiment of the present invention, an olefin-based polymer which has (1) a density of 0.915 to 0.935 g/cm³; (2) a ratio between a melt index (I_{21.6}) measured with a load of 21.6 kg and a melt index (I_{2.16}) measured with a load of 2.16 kg at 190° C. (melt flow ratio; MFR) of 15 or more; and (3) a comonomer distribution slope (CDS) defined by the Equation 1 of 1.0 or more is provided.

In a specific example of the present invention, the olefin-based polymer has the density of 0.915 to 0.935 g/cm³. Preferably, the olefin-based polymer may have the density of 0.918 to 0.932 g/cm³.

In a specific example of the present invention, the olefin-based polymer may have the ratio between a melt index (I_{21.6}) measured with a load of 21.6 kg and a melt index (I_{2.16}) measured with a load of 2.16 kg at 190° C. (melt flow ratio; MFR) of 15 or more. Preferably, the olefin-based polymer may have the MFR of 15 to 40.

In a specific example of the present invention, the olefin-based polymer may have the comonomer distribution slope (CDS) defined by the following Equation 1 of 1.0 or more. Preferably, the olefin-based polymer may have the CDS of 1.0 to 3.0.

$$CDS = \frac{log {C}_{80} - log {C}_{20}}{log {M}_{80} - log {M}_{20}} \qquad [ Equation 1 ]$$

wherein C₂₀ and C₈₀ are comonomer contents at points where cumulative weight fractions are 20% and 80%, respectively, in a comonomer distribution, and M₂₀ and M₈₀ are molecular weights at points where cumulative weight fractions are 20% and 80%, respectively, in a comonomer distribution.

The CDS of the olefin-based polymer represents a slope of a comonomer content to a molecular weight at points where cumulative weight fractions are 20% and 80%, respectively, in a comonomer distribution graph. As the CDS of the olefin-based polymer is higher, a copolymer is concentrated on a polymer chain having a higher molecular weight, so that mechanical strength and heat seal properties may be excellent.

Herein, the comonomer distribution of the olefin-based polymer may be continuously measured with the molecular weight and the molecular weight distribution of the polymer, using GPC-FTIR equipment.

It is understood that since the olefin-based polymer according to an exemplary embodiment of the present invention has a relatively large molecular weight distribution and has more short chain branches in a high molecular weight component, the mechanical strength and heat seal properties of the olefin-based polymer film manufactured therefrom are excellent.

In a specific example of the present invention, the olefin-based polymer may be prepared by polymerizing an olefin-based monomer in the presence of a hybrid catalyst including: at least one first transition metal compound represented by the following Chemical Formula 1; and at least one second transition metal compound represented by the following Chemical Formula 2:

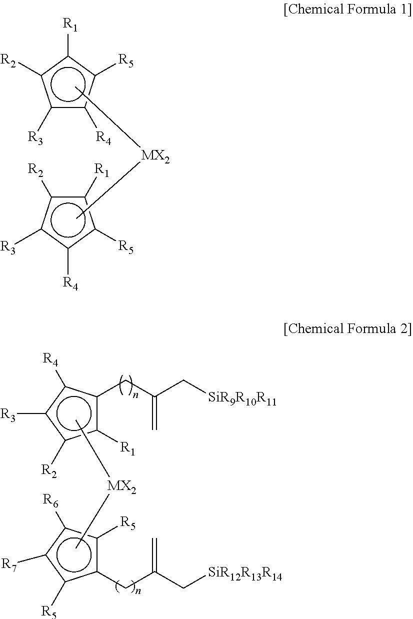

wherein n is independently of each other an integer of 1 to 20, preferably an integer of 1 to 10, and more specifically an integer of 1 to 5. Specifically, n may be 1 or 2, respectively.
M is independently of each other titanium (Ti), zirconium (Zr), or hafnium (Hf). Specifically, M may be zirconium or hafnium, respectively.
X is independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido. Specifically, X may be halogen or C₁₋₂₀ alkyl, respectively. Preferably, X may be chlorine or methyl.
R₁ to R₈ are independently of one another hydrogen, substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, in which R₁ to R₈ may be independently of each other connected to an adjacent group to form a substituted or unsubstituted and saturated or unsaturated C₄₋₂₀ ring. Specifically, R₁ to R₈ may be hydrogen, substituted or unsubstituted C₁₋₂₀ alkyl, substituted or unsubstituted C₁₋₂₀ alkenyl, or substituted or unsubstituted C₆₋₂₀ aryl, respectively.
R₉ to R₁₁ and R₁₂ to R₁₄ are independently of one another substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl. Specifically, R₉ to R₁₁ and R₁₂ to R₁₄ may be independently of one another substituted or unsubstituted C₁₋₂₀ alkyl or substituted or unsubstituted C₆₋₂₀ aryl. Preferably, R₉ to R₁₁ and R₁₂ to R₁₄ may be methyl, respectively.

In a specific example of the present invention, M may be zirconium or hafnium, respectively, X may be halogen or C₁₋₂₀ alkyl, respectively, R₁ to R₈ may be hydrogen, substituted or unsubstituted C₁₋₂₀ alkyl, substituted or unsubstituted C₁₋₂₀ alkenyl, or substituted or unsubstituted C₆₋₂₀ aryl, respectively, and R₉ to R₁₁ and R₁₂ to R₁₄ may be substituted or unsubstituted C₁₋₂₀ alkyl, respectively.

In a preferred specific example of the present invention, the first transition metal compound may be at least one of transition metal compounds represented by the following Chemical Formulae 1-1 to 1-3, and the second transition metal compound may be a transition metal compound represented by the following Chemical Formula 2-1:

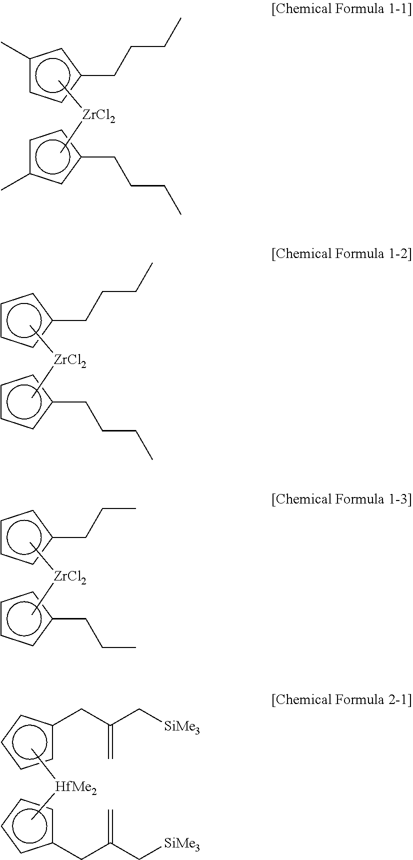

wherein Me is a methyl group.

In a specific example of the present invention, a mole ratio of the first transition metal compound to the second transition metal compound is in a range of 100:1 to 1:100. Preferably, a mole ratio of the first transition metal compound to the second transition metal compound is in a range of 50:1 to 1:50. Preferably, a mole ratio of the first transition metal compound to the second transition metal compound is in a range of 10:1 to 1:10.

In a specific example of the present invention, the catalyst may include at least one cocatalyst compound selected from the group consisting of a compound represented by the following Chemical Formula 3, a compound represented by the following Chemical Formula 4, and a compound represented by the following Chemical Formula 5:

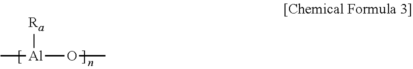

wherein n is an integer of 2 or more, Rₐ is a halogen atom, C₁₋₂₀ hydrocarbon, or C₁₋₂₀ hydrocarbon substituted with halogen, and specifically, R a may be methyl, ethyl, n-butyl, or isobutyl,

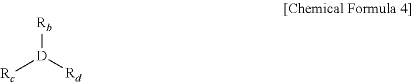

wherein D is aluminum (Al) or boron (B), and R_{b}, R_{C}, and R_{d} are independently of one another a halogen atom, a C₁₋₂₀ hydrocarbon group, a C₁₋₂₀ hydrocarbon group substituted with halogen, or a C₁₋₂₀ alkoxy group, and specifically, when D is aluminum (Al), R_{b}, R_{c}, and R_{d} may be independently of one another methyl or isobutyl, and when D is boron (B), R_{b}, R_{c}, and R_{d} may be pentafluorophenyl, respectively,

[L-H]³⁰[Z(A)₄]⁻ or [L]⁺[Z(A)₄]⁻ [Chemical Formula 5]
wherein L is a neutral or cationic Lewis base, [L-H]⁺ and [L]⁺ are a Bronsted acid, Z is a group 13 element, and A is independently of each other a substituted or unsubstituted C₆₋₂₀ aryl group or a substituted or unsubstituted C₁₋₂₀ alkyl group, and specifically, [L-H]⁺ may be dimethylanilinium cation, [Z(A)₄]⁻ may be [B(C₆F₅)_{4]}⁻, and [L]⁺ may be [(C₆H₅)₃C]⁺.

Specifically, an example of the compound represented by Chemical Formula 3 includes methylaluminoxane, ethylaluminoxane, isobutylaluminoxane, butylaluminoxane, and the like, and is preferably methylaluminoxane, but is not limited thereto.

An example of the compound represented by Chemical Formula 4 includes trimethylaluminum, triethylaluminum, triisobutylaluminum, tripropylaluminum, tributylaluminum, dimethylchloroaluminum, triisopropylaluminum, tri-s-butylaluminum, tricyclopentylaluminum, tripentylaluminum, triisopentylaluminum, trihexylaluminum, trioctylaluminum, ethyldimethylaluminum, methyldiethylaluminum, triphenylaluminum, tri-p-tolylaluminum, dimethylaluminummethoxide, dimethylaluminumethoxide, trimethylboron,triethylboron, triisobutylboron, tripropylboron, tributylboron, and the like, and is preferably trimethylaluminum, triethylaluminum, and triisobutylaluminum, but is not limited thereto.

An example of the compound represented by Chemical Formula 5 includes triethylammoniumtetraphenylboron, tributylammoniumtetraphenylboron, trimethylammoniumtetraphenylboron, tripropylammoniumtetraphenylboron, trimethylammoniumtetra(p-tolyl)boron, trimethylammoniumtetra(o,p-dimethylphenyl)boron, tributylammoniumtetra(p-trifluoromethylphenyl)boron, trimethylammoniumtetra(p-trifluoromethylphenyl)boron, tributylammoniumtetrapentafluorophenylboron, N,N-diethylaniliniumtetraphenylboron, N,N-diethylaniliniumtetrapentafluorophenylboron, diethylammoniumtetrapentafluorophenylboron, triphenylphosphoniumtetraphenylboron, trimethylphosphoniumtetraphenylboron, triethylammoniumtetraphenylaluminum, tributylammoniumtetraphenylaluminum, trimethylammoniumtetraphenylaluminum, tripropylammoniumtetraphenylaluminum, trimethylammoniumtetra(p-tolyl)aluminum, tripropylammoniumtetra(p-tolyl)aluminum, triethylammoniumtetra(o,p-dimethylphenyl)aluminum, tributylammoniumtetra(p-trifluoromethylphenyl)aluminum, trimethylammoniumtetra(p-trifluoromethylphenyl)aluminum, tributylammoniumtetrapentafluorophenylaluminum, N,N-diethylaniliniumtetraphenylaluminum, N,N-diethylaniliniumtetrapentafluorophenylaluminum, diethylammoniumtetrapentatetraphenylaluminum, triphenylphosphoniumtetraphenylaluminum, trimethylphosphoniumtetraphenylaluminum, tripropylammoniumtetra(p-tolyl)boron, triethylammoniumtetra(o,p-dimethylphenyl)boron, tributylammoniumtetra(p-trifluoromethylphenyl)boron, triphenylcarboniumtetra(p-trifluoromethylphenyl)boron, triphenylcarboniumtetrapentafluorophenylboron, and the like.

In a specific example of the present invention, the catalyst may further include a carrier which supports a transition metal compound, a cocatalyst compound, or both of them. Specifically, the carrier may support both the transition metal compound and the cocatalyst compound.

Herein, the carrier may include a material containing a hydroxyl group on the surface, and preferably, may use a material having highly reactive hydroxyl group and siloxane group which is dried to remove moisture from the surface. For example, the carrier may include at least one selected from the group consisting of silica, alumina, and magnesia. Specifically, silica, silica-alumina, silica-magnesia, and the like which are dried at a high temperature may be used as the carrier, and these may usually contain oxide, carbonate, sulfate, and nitrate components such as Na₂O, K₂CO₃, BaSO₄, and Mg(NO₃)₂. In addition, these may include carbon, zeolite, magnesium chloride, and the like. However, the carrier is not limited thereto, and is not particularly limited as long as it may support a transition metal compound and a cocatalyst compound.

The carrier may have an average particle size of 10 to 250 μm, preferably 10 to 150 μm, and more preferably 20 to 100 μm.

The carrier may have a micropore volume of 0.1 to 10 cc/g, preferably 0.5 to 5 cc/g, and more preferably 1.0 to 3.0 cc/g.

The carrier may have a specific surface area of 1 to 1,000 m²/g, preferably 100 to 800 m²/g, and more preferably 200 to 600 m²/g.

In a preferred specific example of the present invention, the carrier may be silica. Herein, a drying temperature of the silica may be 200 to 900° C. The drying temperature may be 300 to 800° C., and more preferably 400 to 700° C. When the drying temperature is lower than 200° C., silica has too much moisture so that the moisture on the surface reacts with the cocatalyst compound, and when the drying temperature is higher than 900° C., the structure of the carrier may collapse.

A concentration of a hydroxyl group in dried silica may be 0.1 to 5 mmol/g, preferably 0.7 to 4 mmol/g, and more preferably 1.0 to 2 mmol/g. When the concentration of the hydroxyl group is less than 0.1 mmol/g, the supported amount of a first cocatalyst compound is lowered, and when the concentration is more than 5 mmol/g, the catalyst component becomes inactive.

The total amount of the transition metal compound supported on the carrier may be 0.001 to 1 mmol based on 1 g of the carrier. When a ratio between the transition metal compound and the carrier satisfies the above range, appropriate supported catalyst activity is shown, which is advantageous in terms of the activity maintenance of a catalyst and economic feasibility.

The total amount of the cocatalyst compound supported on the carrier may be 2 to 15 mmol based on 1 g of the carrier. When the ratio of the cocatalyst compound and the carrier satisfies the above range, it is advantageous in terms of the activity maintenance of a catalyst and economic feasibility.

The carrier may be one or two or more. For example, both the transition metal compound and the cocatalyst compound may be supported on one carrier, or each of the transition metal compound and the cocatalyst compound may be supported on two or more carriers. In addition, only one of the transition metal compound and the cocatalyst compound may be supported on the carrier.

As a method for supporting the transition metal compound and/or the cocatalyst compound which may be used in the catalyst for olefin polymerization, a physical adsorption method or a chemical adsorption method may be used.

For example, the physical adsorption method may be a method including bringing a solution in which a transition metal compound is dissolved into contact with a carrier and then drying, a method including bringing a solution in which a transition metal compound and a cocatalyst compound are dissolved into contact with a carrier and then drying, a method including bringing a solution in which a transition metal compound is dissolved into contact with a carrier and then drying to prepare a carrier on which the transition metal compound is supported, separately bringing a solution in which a cocatalyst compound is dissolved into contact with a carrier and then drying to prepare a carrier on which the cocatalyst compound is supported, and then mixing them, or the like.

The chemical adsorption method may be a method including first supporting a cocatalyst compound on the surface of a carrier and then supporting a transition metal compound on the cocatalyst compound, a method including binding a functional group (for example, a hydroxyl group (—OH) on the surface of silica, in the case of silica) on the surface of a carrier and a catalyst compound covalently.

In a specific example of the present invention, the olefin-based polymer may be a homopolymer of an olefin-based monomer or a copolymer of olefin-based monomer and comonomer. Preferably, the olefin-based polymer is a copolymer of an olefin-based monomer and an olefin-based comonomer.

Herein, the olefin-based monomer may be at least one selected from the group consisting of C₂₋₂₀ α-olefin, C₁₋₂₀ diolefin, C₃₋₂₀ cycloolefin, and C₃₋₂₀ cyclodiolefin.

For example, the olefin-based monomer may be ethylene, propylene, 1-butene, 1-pentene, 4-methyl-1-pentene, 1-hexene, 1-heptene, 1-octene, 1-decene, 1-undecene, 1-dodecene, 1-tetradecene, or 1-hexadecene, and the olefin-based polymer may be a homopolymer including only one or a copolymer including two or more of the olefin-based monomers exemplified above.

In an exemplary embodiment, the olefin-based polymer may be a copolymer of ethylene and C₃₋₂₀ α-olefin. Preferably, the olefin-based polymer may be a linear low-density polyethylene in which the olefin-based monomer is ethylene and the olefin-based comonomer is 1-hexene.

In this case, the content of ethylene is preferably 55 to 99.9 wt %, and more preferably 90 to 99.9 wt %. The content of the α-olefin-based comonomer is preferably 0.1 to 45 wt %, and more preferably 0.1 to 10 wt %.

### Method for Preparing Olefin-Based Polymer

According to an exemplary embodiment of the present invention, a method for preparing an olefin-based polymer including: polymerizing an olefin-based monomer in the presence of a hybrid catalyst including: at least one first transition metal compound represented by the following Chemical Formula 1; and at least one second transition metal compound represented by the following Chemical Formula 2, thereby obtaining an olefin-based polymer is provided:

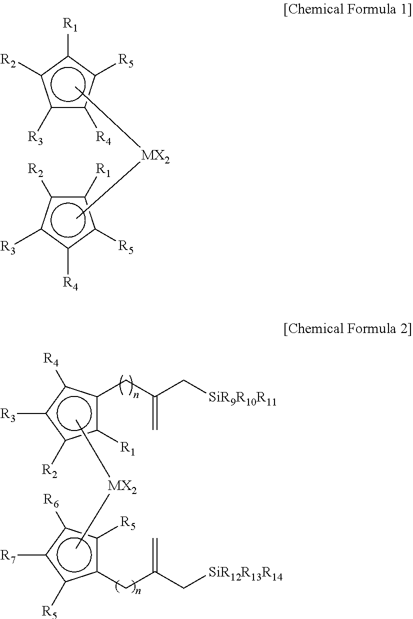

wherein n, M, X, R₁ to R₈, and R₉ to R₁₄ are as defined above in the item of “olefin-based polymer”.

As described above, the olefin-based polymer prepared by the preparation method according to an exemplary embodiment of the present invention may have (1) a density of 0.915 to 0.935 g/cm³, preferably 0.918 to 0.932 g/cm³; (2) a ratio between a melt index (I_{21.6}) measured with a load of 21.6 kg and a melt index (I_{2.16}) measured with a load of 2.16 kg at 190° C. (melt flow ratio; MFR) of 15 or more, preferably 15 to 40; and (3) a comonomer distribution slope (CDS) defined by the following Equation 1 of 1.0 or more, preferably 1.0 to 3.0:

$$CDS = \frac{log {C}_{80} - log {C}_{20}}{log {M}_{80} - log {M}_{20}} \qquad [ Equation 1 ]$$

wherein C₂₀, C₈₀, M₂₀, and M₈₀ are as defined above in the item of “olefin-based polymer”.

In a specific example of the present invention, the olefin-based polymer may be polymerized by a polymerization reaction such as free radical, cationic, coordination, condensation, and addition polymerization, but is not limited thereto.

In an exemplary embodiment of the present invention, the olefin-based polymer may be prepared by a gas phase polymerization method, a solution polymerization method, a slurry polymerization method, or the like. Preferably, the polymerization of the olefin-based monomer may be performed by slurry polymerization, and specifically, the polymerization of the olefin-based monomer may be performed in a slurry batch reactor.

When the olefin-based polymer is prepared by a solution polymerization method or a slurry polymerization method, an example of the solvent to be used may include a C₅₋₁₂ aliphatic hydrocarbon solvent such as pentane, hexane, heptane, nonane, decane, and isomers thereof; an aromatic hydrocarbon solvent such as toluene and benzene; a hydrocarbon solvent substituted with a chlorine atom such as dichloromethane and chlorobenzene; and a mixture thereof, but is not limited thereto.

### BEST MODE FOR CARRYING OUT THE INVENTION

### EXAMPLES

Hereinafter, the present invention will be described in more detail through the following examples. However, the following examples are only illustrative of the present invention, and do not limit the scope of the present invention.

### Preparation Example

The transition metal compound of Chemical Formula 1-1 (bis[(1-butyl-3-methyl)cyclopentadienyl]zirconium dichloride) and the transition metal compound of Chemical Formula 1-2 (bis(n-butylcyclopentadienyl)zirconium dichloride) were purchased from TCI, and the transition metal compound of Chemical Formula 2-1 was prepared as follows.

### Preparation of 2-(trimethylsilylmethyl)-2-propen-1-ol

A potassium carbonate (K₂CO₃) aqueous solution (6.6 M, 14.4 mmol) was slowly added to a solution in which 2-(trimethylsilylmethyl)allyl acetate (2.69 g, 14.4 mmol) was dissolved in methanol (22 ml). After the addition, it was stirred at room temperature for 4 hours. After the stirring, water was added thereto to complete the reaction. Diethyl ether was used to extract an organic layer, and then the remaining water was removed with magnesium sulfate (MgSO₄). All solvents were removed under vacuum to obtain 1.51 g (72%) of a light ivory oil compound.

¹H-NMR (CDCl₃, 300 MHz): δ 4.90-4.88 (m, 1H), 4.66 (s, 1H), 3.97 (s, 2H), 1.53 (s, 2H), 0.03 (s, 9H).

### Preparation of 2-(trimethylsilylmethyl) Methanesulfonate

Methanesulfonyl chloride (1.8 g, 15.7 mmol) was slowly added at 0° C. to a solution in which 2-(trimethylsilylmethyl)-2-propen-1-ol (1.51 g, 10.5 mmol) and triethylamine (1.91 g, 18.8 mmol) were diluted with dichloromethane (30 ml). Thereafter, stirring was performed at 0° C. for 3 hours. A sodium hydrogen carbonate (NaHCO₃) aqueous solution was added at 0° C. to complete the reaction, and then extraction was performed with dichloromethane to separate an organic layer. The remaining water was removed with sodium sulfate (Na₂SO₄). and then all solvents were removed under vacuum to obtain 1.9 g (82%) of a yellow oil compound.

¹H-NMR (CDCl₃, 300 MHz): δ5.03 (d, 1H), 4.84 (s, 1H), 4.56 (s, 2H), 3.02 (s, 3H), 1.60 (s, 2H), 0.06 (s, 9H).

### Preparation of 2-(trimethylsilylmethyl)allyl Bromide

A solution in which lithium bromide was dispersed in tetrahydrofuran (15 ml) was slowly added at room temperature to a solution in which 2-(trimethylsilylmethyl) methanesulfonate (1.9 g, 8.54 mmol) was diluted with 20 ml of tetrahydrofuran (THF), and then stirring was performed at 110° C. for 4 hours. Distilled water was added at 0° C. to complete the reaction, and then extraction was performed with diethyl ether to separate an organic layer. The remaining water was removed with sodium sulfate (Na₂SO₄), and then all solvents were removed under vacuum to obtain 1.12 g (65%) of a yellow oil compound.

¹H-NMR (CDCl₃, 300 MHz): δ5.04 (s, 1H), 4.74 (d, 1H), 3.90 (d, 2H), 1.72 (d, 2H), 0.05 (s, 9H).

### Preparation of [2-(cyclopentadienylmethyl)allyl] Trimethylsilane

Sodium cyclopentadienide (3.04 g, 6.49 mmol, 2M THF solution) was slowly added dropwise at −30° C. to a solution in which 2-(trimethylsilylmethyl)allyl bromide (1.12 g, 5.41 mmol) was diluted with tetrahydrofuran (20 ml), the temperature was slowly raised to room temperature, and stirring was performed for 12 hours. Distilled water was added at 0° C. to complete the reaction, and then extraction was performed with diethyl ether to separate an organic layer. The remaining water was removed with magnesium sulfate, and then separation was performed with column chromatography (hexane) to obtain 620 mg (60%) of a light ivory oil compound.

¹H-NMR (CDCl₃, 300 MHz): δ6.42-6.02 (m, 4H), 4.60-4.55 (m, 2H), 3.06-2.97 (m, 2H), 2.87-2.85 (m, 2H), 1.54 (s, 2H), 0.03 (d, 9H).

### Preparation of [2-(trimethylsilylmethyl)allyl] Cyclopentadienyl Lithium

n-Butyllithium (n-BuLi) (1.44 g, 2.93 mmol, 1.6 M hexane solution) was slowly added at −30° C. to a solution in which [2-(cyclopentadienylmethyl)allyl] trimethylsilane (620 mg, 3.22 mmol) was diluted with tetrahydrofuran (10 ml), the temperature was slowly raised to room temperature, and stirring was performed for 12 hours. The solvent of the reaction solution was dried under vacuum, hexane was added thereto, and stirring was performed for 15 minutes. A produced solid was filtered and dried under vacuum to obtain 528 mg (83%) of a light yellow solid compound.

### Preparation of bis[(2-trimethylsilylmethylallyl)cyclopentadienyl] Hafnium Dichloride

A solution in which hafnium chloride (HfCl₄) (226 mg, 0.71 mmol) was dispersed in toluene (2 ml) was slowly added at −30° C. to a solution in which [(2-trimethylsilylmethyl)allyl] cyclopentadienyl lithium (280 mg, 1.41 mmol) was diluted with toluene (3 ml), the temperature was slowly raised to room temperature, and stirring was performed for 12 hours. When the reaction was completed, the reaction solution was filtered, and the solvent of a filtrate was dried under vacuum. A produced solid was washed with hexane and dried to obtain 180 mg (41%) of a white solid compound.

¹H-NMR (CDCl₃, 300 MHz): δ6.21 (t, 2H), 6.12 (t, 2H), 4.54 (d, 2H), 4.44 (d, 1H), 3.28 (s, 2H), 1.52 (s, 2H), 0.05 (s, 9H).

### Preparation of bis[(2-trimethylsilylmethylallyl) cyclopentadienyl] Hafnium Dimethyl

MeMgBr (3.93 g, 11.4 mmol, 3.0 M diethyl ether solution) was slowly added at −30° C. to a solution in which bis[(2-trimethylsilylmethylallyl)cyclopentadienyl] hafnium dichloride (2.4 g, 3.79 mmol) was diluted with toluene (40 ml), the temperature was slowly raised to room temperature, and stirring was performed for 12 hours. After completing the reaction, extraction was performed with toluene and filtration was performed. Toluene was removed under vacuum, and washing with hexane and drying were performed to obtain 2.08 g (93%) of a white solid compound.

### Preparation Example 1

8.71 g of a 10% toluene solution of methylaluminoxane was added to 17.9 mg of the transition metal compound of Chemical Formula 1-1 and 57.0 mg of the transition metal compound of Chemical Formula 2-1, and the solution was stirred at room temperature for 1 hour. The resulting solution after the reaction was added to 1.94 g of silica (XPO-2402), 15 ml of toluene was further added, and stirring was performed at 70° C. for 2 hours. The catalyst which had been supported was washed three times using 5 mL of toluene, and was dried overnight at 60° C. under vacuum to obtain 2.80 g of a supported catalyst in a powder form.

### Preparation Example 2

2.6 g of a supported catalyst was obtained in the same manner as in Preparation Example 1, except that 15.5 g of the transition metal compound of Chemical Formula 1-2 were used instead of the transition metal compound of Chemical formula 1-1.

### Examples 1 to 8

Ethylene/1-hexene copolymers were prepared in the presence of the supported catalysts, each of which was obtained in Preparation Examples 1 and 2, using a slurry batch polymerization reactor. The polymerization conditions of the examples are summarized in the following Table 1:

TABLE 1

| Classification | Example 1 | Example 2 | Example 3 | Example 4 | Example 5 | Example 6 | Example 7 | Example 8 |
|---|---|---|---|---|---|---|---|---|
| Catalyst | Preparation | Preparation | Preparation | Preparation | Preparation | Preparation | Preparation | Preparation |
| | Example 1 | Example 1 | Example 1 | Example 1 | Example 2 | Example 2 | Example 2 | Example 2 |
| Hydrogen | 0 | 1 | 3 | 5 | 0 | 1 | 3 | 5 |
| injection | | | | | | | | |
| amount | | | | | | | | |
| (ml/min) | | | | | | | | |
| 1-Hexene | 50 | 50 | 50 | 50 | 50 | 50 | 50 | 50 |
| injection | | | | | | | | |
| amount | | | | | | | | |
| (ml) | | | | | | | | |
| Polymerization | 80 | 80 | 80 | 80 | 80 | 80 | 80 | 80 |
| temperature | | | | | | | | |
| (° C.) | | | | | | | | |
| Polymerization | 14 | 14 | 14 | 14 | 14 | 14 | 14 | 14 |
| pressure | | | | | | | | |
| (bar) | | | | | | | | |
| Catalytic | 1,460 | 2,060 | 2,040 | 2,260 | 2,780 | 3,580 | 3,580 | 4,160 |
| activity | | | | | | | | |
| (gPE/gCat-hr) | | | | | | | | |

### Comparative Examples 1 and 2

For comparison, linear low-density polyethylenes M181OHN (density: 0.9180 g/cm³, melt index: 1.0 g/10 min; Comparative Example 1) and M2010EN (density: 0.9200 g/cm³, melt index: 1.0 g/10 min; Comparative Example 2) available from Hanwha Solutions were used.

### Test Example

The physical properties of the olefin-based polymer of the above examples were measured by the following methods and criteria. The results are shown in the following Tables 2 and the 3.

### (1) Density

Measured according to ASTM D 1505.

### (2) MELT INDEX and Melt Index Ratio (MFR)

The melt index was measured with a load of 21.6 kg and a load of 2.16 kg, respectively, at 190° C. in accordance with ASTM D1238, and the ratio (MI_{21.6}/MI_{2.16}) was calculated.

### (3) Comonomer Distribution Slope (CDS)

Measured at 170° C. using gel permeation chromatography-FTIR (GPC-FTIR).

TABLE 2

| | | Example | Example | Example | Example | Example |
|---|---|---|---|---|---|---|
| | Unit | 1 | 2 | 3 | 4 | 5 |
| Melt | g/10 min | 0.08 | 0.31 | 0.44 | 1.46 | 1.5 |
| index | | | | | | |
| MFR | — | 25.4 | 20.4 | 21.4 | 23.5 | 16.9 |
| Density | g/cm³ | 0.9204 | 0.9255 | 0.9265 | 0.9300 | 0.9250 |
| Mw | g/mol | 256,087 | 196,819 | 188,490 | 148,642 | 148,898 |
| Mw/Mn | — | 6.51 | 5.49 | 6.14 | 6.44 | 6.99 |
| CDS | — | 1.96 | 1.36 | 1.08 | 1.75 | 1.34 |

TABLE 3

| | | Example | Example | Example | Comparative | Comparative |
|---|---|---|---|---|---|---|
| | Unit | 6 | 7 | 8 | Example 1 | Example 2 |
| Melt | g/10 min | 2.04 | 2.28 | 4.04 | 0.29 | 0.003 |
| index | | | | | | |
| MFR | — | 17 | 16.1 | 18 | 20.7 | 403 |
| Density | g/cm³ | 0.9287 | 0.9313 | 0.9323 | 0.9270 | 0.9165 |
| Mw | g/mol | 137,279 | 138,929 | 119,924 | 168,282 | 258,327 |
| Mw/Mn | — | 5.76 | 5.74 | 5.26 | 2.12 | 3.91 |
| CDS | — | 1.66 | 1.39 | 2.26 | 0.37 | 0.37 |

### INDUSTRIAL APPLICABILITY

Since the olefin-based polymer according to an exemplary embodiment of the present invention has a wide molecular weight distribution and thus has excellent processability, and has a relatively large number of short-chain branches in high molecular weight components, the olefin-based polymer has excellent mechanical strength and heat seal properties.

1. An olefin-based polymer which has (1) a density of 0.915 to 0.935 g/cm³; (2) a ratio between a melt index (I_{21.6}) measured with a load of 21.6 kg and a melt index (I_{2.16}) measured with a load of 2.16 kg at 190° C. (melt flow ratio;
MFR) of 15 or more; and (3) a comonomer distribution slope (CDS) defined by the following Equation 1 of 1.0 or more:
$$CDS = \frac{log {C}_{80} - log {C}_{20}}{log {M}_{80} - log {M}_{20}} \qquad [ Equation 1 ]$$
wherein C₂₀ and C₈₀ are comonomer contents at points where cumulative weight fractions are 20% and 80%, respectively, in a comonomer distribution, and M₂₀ and M₈₀ are molecular weights at points where cumulative weight fractions are 20% and 80%, respectively, in a comonomer distribution.

2. The olefin-based polymer of claim 1, wherein the olefin-based polymer has (1) the density of 0.918 to 0.932 g/cm³; (2) the MFR of 15 to 40; and (3) the CDS of 1.0 to 3.0.

3. The olefin-based polymer of claim 1, wherein the olefin-based polymer is prepared by polymerizing an olefin-based monomer in the presence of a hybrid catalyst including: at least one first transition metal compound represented by the following Chemical Formula 1; and at least one second transition metal compound represented by the following Chemical Formula 2: 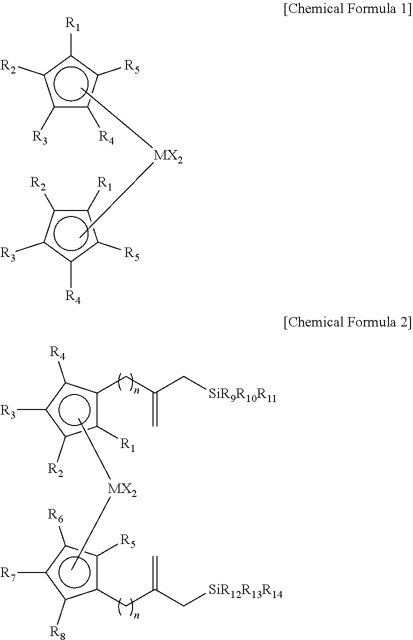
wherein n is independently of each other an integer of 1 to 20,
M is independently of each other titanium (Ti), zirconium (Zr), or hafnium (Hf),
X is independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido,
R₁ to R₈ are independently of one another hydrogen, substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, and
R₉ to R₁₁ and R₁₂ to R₁₄ are independently of one another substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, but
R₁ to R₈ may be independently of one another connected to an adjacent group to form a substituted or unsubstituted and saturated or unsaturated C₄₋₂₀ ring.

4. The olefin-based polymer of claim 3, wherein M is zirconium or hafnium, respectively, X is halogen or C₁₋₂₀ alkyl, respectively, R₁ to R₈ are hydrogen, substituted or unsubstituted C₁₋₂₀ alkyl, substituted or unsubstituted C₁₋₂₀ alkenyl, or substituted or unsubstituted C₆₋₂₀ aryl, respectively, and R₉ to R₁₁ and R₁₂ to R₁₄ are substituted or unsubstituted C₁₋₂₀ alkyl, respectively.

5. The olefin-based polymer of claim 3, wherein the first transition metal compound is at least one of transition metal compounds represented by the following Chemical Formulae 1-1 to 1-3, and the second transition metal compound is a transition metal compound represented by the following Chemical Formula 2-1: 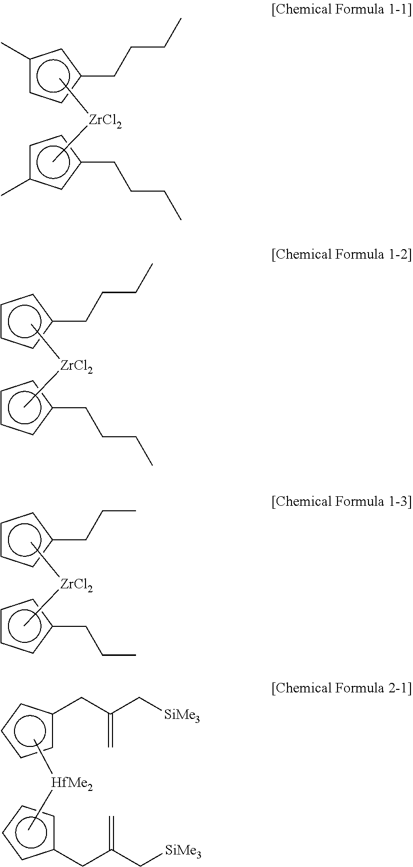
wherein Me is a methyl group.

6. The olefin-based polymer of claim 3, wherein a mole ratio of the first transition metal compound to the second transition metal compound is in a range of 100:1 to 1:100.

7. The olefin-based polymer of claim 3, wherein the catalyst comprises at least one cocatalyst compound selected from the group consisting of a compound represented by the following Chemical Formula 3, a compound represented by the following Chemical Formula 4, and a compound represented by the following Chemical Formula 5: 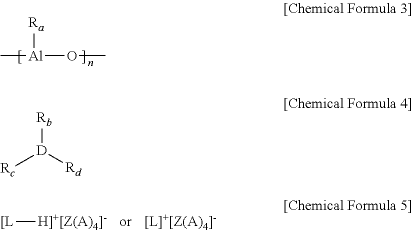
wherein n is an integer of 2 or more, Rₐ is a halogen atom, a C₁₋₂₀ hydrocarbon group, or a C₁₋₂₀ hydrocarbon group substituted with halogen,
D is aluminum (Al) or boron (B), R_{b}, R_{c}, and R_{d} are independently of one another a halogen atom, a C₁₋₂₀ hydrocarbon group, a C₁₋₂₀ hydrocarbon group substituted with halogen, or a C₁₋₂₀ alkoxy group,
L is a neutral or cationic Lewis base, [L-H]⁺ and [L]⁺ are a Bronsted acid, Z is a group 13 element, and A is independently of each other a substituted or unsubstituted C₆₋₂₀ aryl group or a substituted or unsubstituted C₁₋₂₀ alkyl group.

8. The olefin-based polymer of claim 7, wherein the catalyst further comprises a carrier which supports the transition metal compound, the cocatalyst compound, or both of them.

9. The olefin-based polymer of claim 8, wherein the carrier comprises at least one selected from the group consisting of silica, alumina, and magnesia.

10. The olefin-based polymer of claim 8, wherein a total amount of the hybrid transition metal compound supported on the carrier is 0.001 to 1 mmol based on 1 g of the carrier, and a total amount of the cocatalyst compound supported on the carrier is 2 to 15 mmol based on 1 g of the carrier.

11. The olefin-based polymer of claim 1, wherein the olefin-based polymer is a copolymer of an olefin-based monomer and an olefin-based comonomer.

12. The olefin-based polymer of claim 11, wherein the olefin-based monomer is ethylene, and the olefin-based comonomer is one or more selected from the group consisting of propylene, 1-butene, 1-pentene, 4-methyl-1-pentene, 1-hexene, 1-heptene, 1-octene, 1-decene, 1-undecene, 1-dodecene, 1-tetradecene, and 1-hexadecene.

13. The olefin-based polymer of claim 12, wherein the olefin-based polymer is a linear low-density polyethylene in which the olefin-based monomer is ethylene and the olefin-based comonomer is 1-hexene.

14. A method for preparing an olefin-based polymer, the method comprising: polymerizing an olefin-based monomer in the presence of a hybrid catalyst including: at least one first transition metal compound represented by the following Chemical Formula 1; and at least one second transition metal compound represented by the following Chemical Formula 2, thereby obtaining an olefin-based polymer, wherein the olefin-based polymer has (1) a density of 0.915 to 0.935 g/cm³; (2) a ratio between a melt index (I_{21.6}) measured with a load of 21.6 kg and a melt index (I_{2.16}) measured with a load of 2.16 kg at 190° C. (melt flow ratio; MFR) of 15 or more; and (3) a comonomer distribution slope (CDS) defined by the following Equation 1 of 1.0 or more: 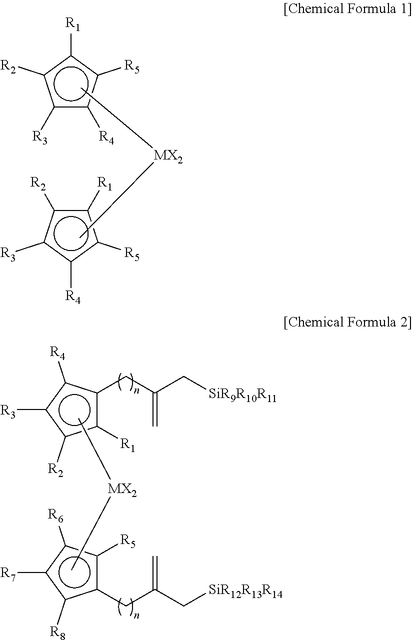
$$CDS = \frac{log {C}_{80} - log {C}_{20}}{log {M}_{80} - log {M}_{20}} \qquad [ Equation 1 ]$$
wherein n, M, X, R₁ to R₈, and R₉ to R₁₄ are as defined in claims 3, and C₂₀, C₈₀, M₂₀, and M₈₀ are as defined in claim 1.

15. The method for preparing an olefin-based polymer of claim 14, wherein the polymerization of the olefin-based monomer is performed by slurry polymerization.
